(19) United States
(12) Patent Application Publication
(10) Pub. No.: US 2026/0126324 A1
(43) Pub. Date: May 7, 2026

(54) TRANSPARENT CERAMIC WINDOWS FOR HYPERSONIC APPLICATION

(71) Applicant: Battelle Memorial Institute, Columbus, OH (US)

(72) Inventors: Krenar SHQAU, Westerville, OH (US); Amy Marie HEINTZ, Pacific Grove, CA (US); Erica S. HOWARD, Upper Arlington, OH (US); Ian HAGGERTY, Powell, OH (US); Phil DENEN, Reynoldsburg, OH (US)

(21) Appl. No.: 19/117,129

(22) PCT Filed: Oct. 4, 2023
(86) PCT No.: PCT/US23/75899

§ 371 Date: Mar. 31, 2025

Related U.S. Application Data
(60) Provisional application No. 63/378,438, filed on Oct. 5, 2022.

(51) Int. Cl. G01J 5/0875; B01F 23/50; C04B 35/575; C04B 35/624; C04B 35/626; G01J 5/04

(52) U.S. Cl. CPC G01J 5/0875; B01F 23/551; B01F 23/56; C04B 35/575; C04B 35/624; C04B 35/6267; G01J 5/046; C04B 2235/3834; C04B 2235/608; C04B 2235/666; C04B 2235/9653

(57) ABSTRACT

In an approach to synthesizing transparent ceramic windows, a powder is synthesized. A green body is fabricated from the powder. The green body is densified.

### CROSS-REFERENCE TO RELATED APPLICATIONS

This application is a National Phase application filed under 35 USC § 371 of PCT Application No. PCT/US23/75899 with an international filing date of Oct. 4, 2023, which claims the benefit of the filing date of U.S. Provisional Application Ser. No. 63/378,438, filed Oct. 5, 2022, the entire teachings of which is hereby incorporated herein by reference.

### TECHNICAL FIELD

The present application relates generally to ceramic materials and, more particularly, to transparent ceramic windows for hypersonic applications.

### BACKGROUND

Many aircraft, such as airplanes, helicopters, unmanned vehicles, and missiles (e.g., infrared (IR) seeking missiles), include a seeker that utilizes IR radiation to track one or more targets. In the example of a missile, the seeker typically includes an IR sensor that is positioned within the body of the missile (e.g., in the nose cone) and oriented to detect IR radiation through a ceramic window that is at least partially transparent to such radiation. The transparent ceramic window can be subject to very high heat loads from the compressed air during flight, resulting in a significant temperature gradient across the window. That temperature gradient can impart significant thermal stresses to the window, potentially leading to failure of the window and destruction and/or malfunction of the aircraft.

There is a need for aircraft capable of hypersonic flight at speeds ranging from Mach 1 to Mach 20 that include IR tracking capability. At such operating conditions, the transparent ceramic window will be subject to high heat loads as the speed of the aircraft increases. If the transparent ceramic window cannot withstand such conditions, it may catastrophically fail, resulting in loss or malfunction of the aircraft. Existing transparent ceramic window materials such as sapphire and aluminum oxynitride have been studied as potential materials for use as a hypersonic IR window due to their good thermal resistance and transparency to IR radiation in wavelength ranges of interest. However, such materials do not perform well as an IR seeker window at hypersonic conditions due to the thermal shock (temperature gradients in the material) that is imposed on the material during flight at such conditions, which can impose thermal stress on the window that exceeds the strength of such materials.

### BRIEF DESCRIPTION OF THE DRAWINGS

Reference should be made to the following detailed description which should be read in conjunction with the following figures, wherein like numerals represent like parts.

FIG. 1 is an example of the impact of light scattering mechanisms on the transparency of polycrystalline ceramic windows.

FIG. 2 is a Venn diagram representing some of the defects that may reduce the optical transmittance of polycrystalline ceramics.

FIG. 3 is an example graph of the effect of grain size on the light transmittance of polycrystalline ceramics.

FIG. 4 is an example graph of process temperature versus the rate of grain growth in the manufacture of polycrystalline ceramics.

FIG. 5 is a Venn diagram representing some of the factors affecting overall ceramic properties of polycrystalline ceramics.

FIG. 6 is an example block diagram illustrating factors affecting the final sintering process, consistent with the present disclosure.

FIG. 7 is an illustrative example of one embodiment of a process flow for manufacturing transparent ceramic windows for hypersonic applications, consistent with the present disclosure.

FIG. 8 is a flow chart diagram of workflow 800 depicting operations for the synthesis of a transparent ceramic window for hypersonic applications, in accordance with an embodiment of the present disclosure.

FIG. 9 is an illustration of a colloidal process, consistent with the present disclosure.

FIG. 10 is an illustration of a colloidal process using vacuum filtration, consistent with the present disclosure.

FIG. 11 demonstrates the effect of the sintering temperature on grain growth.

### DETAILED DESCRIPTION

The present disclosure is not limited in its application to the details of construction and the arrangement of components set forth in the following description or illustrated in the drawings. The examples described herein may be capable of other embodiments and of being practiced or being conducted in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

The major limitation of advancing the operational capability of IR seekers for hypersonic flight is the lack of materials capable of surviving thermal shock. Traditional materials (such as alumina) with high optical transparency do not perform well in hypersonic conditions due to the effects of thermal shock, leading to thermal stress that exceeds their principal strength. Therefore, thermal shock is considered as a figure of merit (FOM) that provides a measure of the susceptibility of a material to thermal shock. This value is directly proportional to thermal conductivity and bend strength and inversely proportional to the modulus and coefficient of thermal expansion. As shown in Table 1, beta silicon carbide (β-SiC) polycrystalline ceramic has a significantly higher thermal shock FOM when compared to traditional IR window materials.

TABLE 1

| Material properties | Sapphire | Fuse Silica | Spinel | β-SiC |
|---|---|---|---|---|
| κ (w/m · K⁻¹) | 35-40 | 1.4 | 14.6-18 | 220 |
| CTE (10⁻⁶· K⁻¹) | 5.0-6.6 | 0.31-0.55 | 0.56 | 3.8 |
| dn/dT (10⁻⁶ · K⁻¹) | 13 | 10 | 3 | n/a |
| Strength (MPa) | 700 | 50-75 | 100-200 | 600 |
| Transmission range (μm) | 0.2-4.7 | 0.2-2.0 | 0.2-5 | 0.4-5.0 |
| Thermal shock FOM | 4.3-9.7 | 2.6 | 1.1-1.9 | 77 |

β-SiC polycrystalline ceramic satisfies key properties, such as high strength, low thermal expansion, very high conductivity, and low thermo-optic constant, required for advancing the operational capability of IR seekers for hypersonic flight.

The current commercially available SiC transparent ceramics are limited to either small transparent vapor grown disks or larger opaque shapes, neither of which are useful as a window for hypersonic applications. There exists a need for a transparent window for IR seekers for hypersonic flight with sufficient thermal shock resistance which can be manufactured in sizes large enough for IR seeker for hypersonic flight applications.

Disclosed herein is a process to manufacture transparent windows of sufficient size and transparency with sufficient thermal shock resistance for IR seekers for hypersonic flight. Colloidal processing disclosed herein results in the formation of ceramics with a size of one inch or greater in diameter with minimal macro-defects and with a dense-packed, quasi-homogeneous structure able to prevent abnormal grain growth during sintering. Grain growth is the primary cause of decaying optical transparency of the final product.

The processing of ceramic β-SiC powder is used to prevent the formation of undesired SiC aggregates responsible for microstructural defects in the final ceramic. Utilizing a colloidal filtration method to produce transparent polycrystalline ceramic compacts with minimal macro defects and increased particle packing uniformity in the green body, which, in turn, leads to better microstructural control during sintering process via a rapid thermal treatment. In some embodiments, the rapid thermal treatment may use the Spark-Plasma-Sintering method (SPS). Macro-defects, which negatively affect transmittance, are drastically reduced in population as well as in size. Transparent β-SiC polycrystalline ceramic is disclosed herein for IR seeker windows for hypersonic flight due to its superior properties such as high strength, low thermal expansion, high thermal conductivity, and thermo-optic constant when compared to current IR window materials.

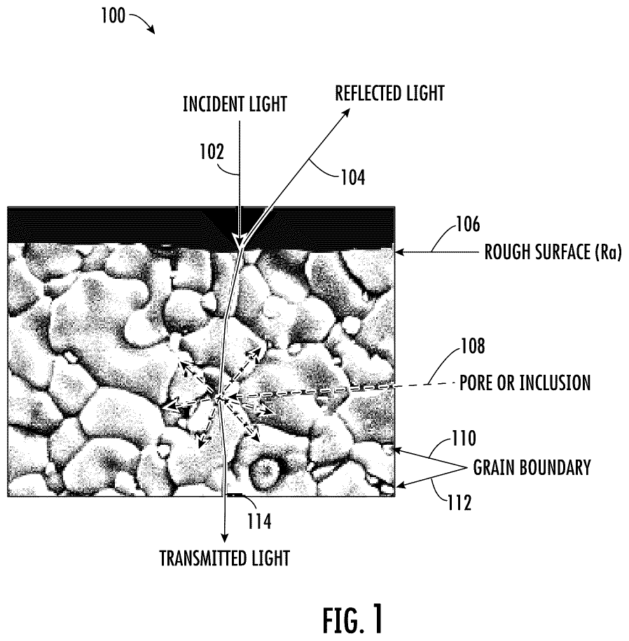

FIG. 1 is an example of the impact of light scattering mechanisms on the transparency of polycrystalline ceramic windows. Optical transmittance of polycrystalline ceramics may be compromised by a number of light scattering inhomogeneities, for example, surface roughness, second-phase inclusions, pores, and grain boundaries. In the example of FIG. 1, incident light 102 is divided into reflected light 104 and transmitted light 114 by a rough surface 106. The transmitted light 114 that passes through rough surface 106 may then encounter other impurities, such as a pore (or inclusion) 108, which scatters the transmitted light 114, or grain boundaries 110 and 112.

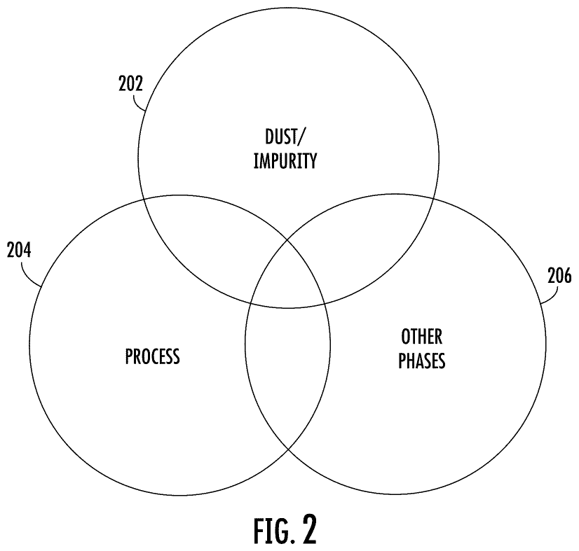

FIG. 2 is a Venn diagram representing some of the defects that may reduce the optical transmittance of polycrystalline ceramics. As noted in FIG. 1 above, optical transmittance of polycrystalline ceramics may be compromised by a number of light scattering inhomogeneities. Defects can reduce optical transmittance. Defects may result from dust or other impurities 202, from the manufacturing process 204 itself, and from other phases 206 of the composition. Defects form because of several factors including inert contamination, bubbles formed during the manufacturing process, or contaminants that chemically react with SiC.

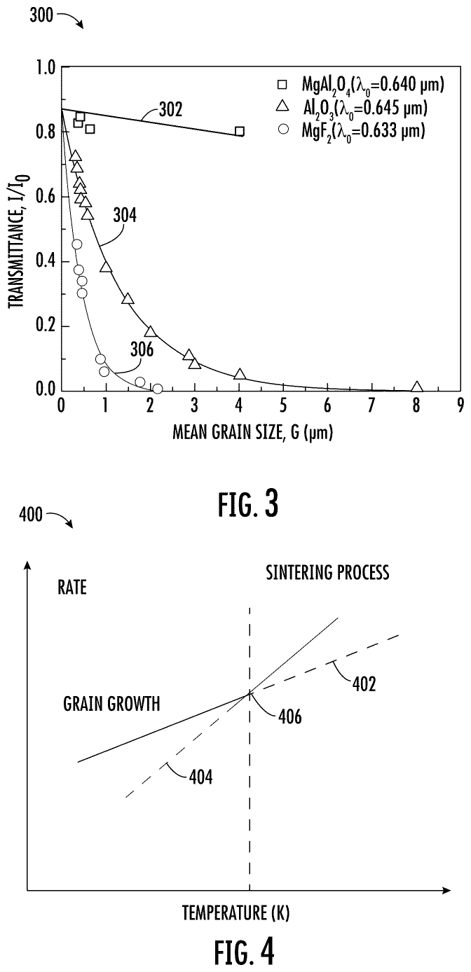

FIG. 3 is an example graph of the effect of grain size on the light transmittance of polycrystalline ceramics. Grain size also affects the light transmittance in polycrystalline ceramics due to birefringent crystals. Birefringence is the optical property of a material having a refractive index that depends on the polarization and propagation direction of light. As shown in the graph of FIG. 3, optical transmittance of polycrystalline ceramics decreases with increasing grain size.

The example of FIG. 3 illustrates some representative data for three polycrystalline ceramics, including spinel (MgAl₂O₄, cubic) 302, aluminum oxide (Al₂O₃) 304, and magnesium fluoride (MgF₂) 306. As can be observed from the graph of FIG. 3, the decrease of in-line transmittance with grain size is most pronounced for magnesium fluoride 306, which has the highest birefringence (the maximum delta refractive index (Δnₘₐₓ)=0.012), while the transmittance of spinel 302 is almost independent of grain size due to its cubic structure and birefringence (Δnₘₐₓ=0). Aluminum oxide 304 exhibits intermediate behavior (Δnₘₐₓ=0.008).

FIG. 4 is an example graph of process temperature versus the rate of grain growth in the manufacture of polycrystalline ceramics. As shown in the graph of FIG. 3 above, optical transmittance of polycrystalline ceramics decreases with increasing grain size. The transparent ceramic windows for hypersonic applications disclosed herein are manufactured using a rapid thermal process since there is little to no grain growth during sintering. The rapid heating rate of the sintering process avoids abnormal grain growth and yields a small grain size.

In the example graph of FIG. 4, line 402 represents the rate of grain growth over increasing temperature, while line 404 represents the rate of grain growth during the sintering process. The example graph of FIG. 4 illustrates that above the crossover temperature 406 the process consists primarily of sintering, and therefore little or no grain growth occurs above this temperature.

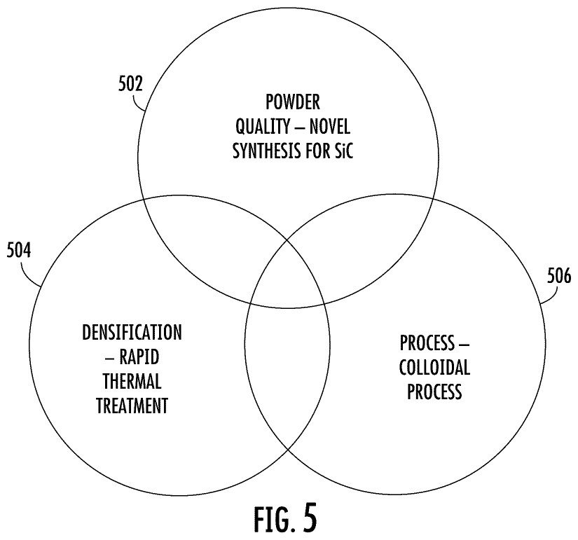

FIG. 5 is a Venn diagram representing some of the factors affecting overall ceramic properties of polycrystalline ceramics. Crucial factors defining optical properties of the ceramics include the presence of pores (reduced by full densification and hot forging), grain size (the use of rapid heat treatment to prevent grain growth), and the inclusion of impurities, e.g., graphite, into the structure (the use of a sol-gel synthesis process to minimize impurities). In the diagram of FIG. 5, these factors include powder quality 502, densification 504, and process 506. The powder quality 502 involves the synthesis of SiC as described herein. The densification 504 refers to the rapid thermal treatment of the powder to avoid or minimize grain growth, as shown in FIG. 4 above, as well as to minimize the presence of pores. The process 506 is a colloidal process, which creates a green body with a density of at least 60%. The manufacture of transparent ceramic for IR seeker windows requires high powder quality, a clean room atmosphere, colloidal stability able to attain a 60% (or higher) dense green body, drying and organic removal, and forge hot pressing or Spark-Plasma-Sintering for high density to avoid grain growth. In some embodiments, CO₂ critical drying may be used for removal of organics.

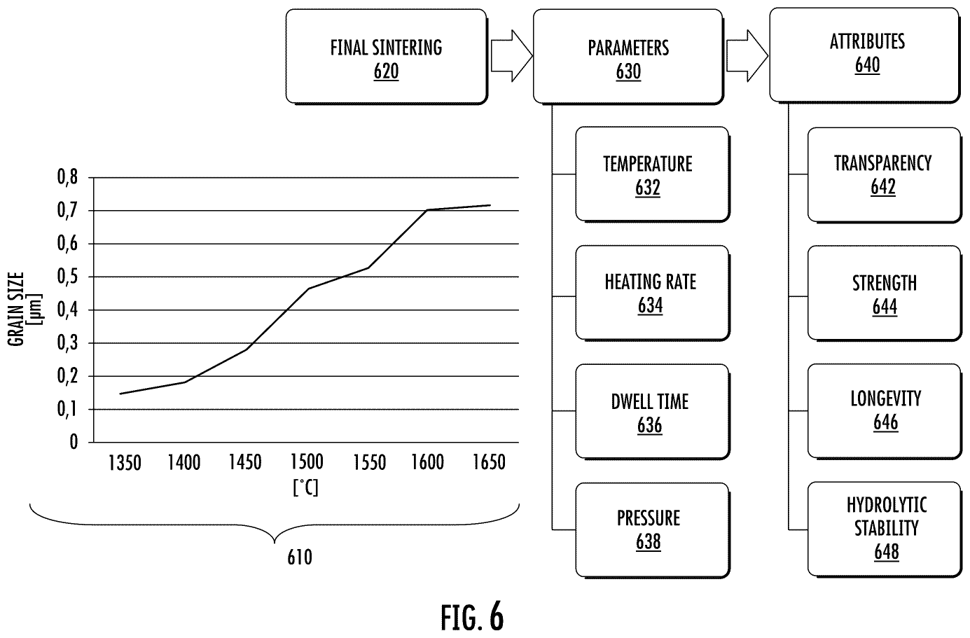

FIG. 6 is an example block diagram illustrating factors affecting the final sintering process, consistent with the present disclosure. In the example block diagram of FIG. 6, graph 610 illustrates the grain size of the polycrystalline ceramic as a function of the temperature of the process. Final sintering process 620 uses parameters 630 to control the attributes 640 of the resulting polycrystalline ceramics. Some of the parameters 630 of the sintering process may include, but are not limited to, temperature 632, heating rate 634, dwell time 636, and pressure 638. The attributes 640 that may be controlled by the parameters 630 may include, but are not limited to, transparency 642, strength 644, longevity 646, and hydrolytic stability 648.

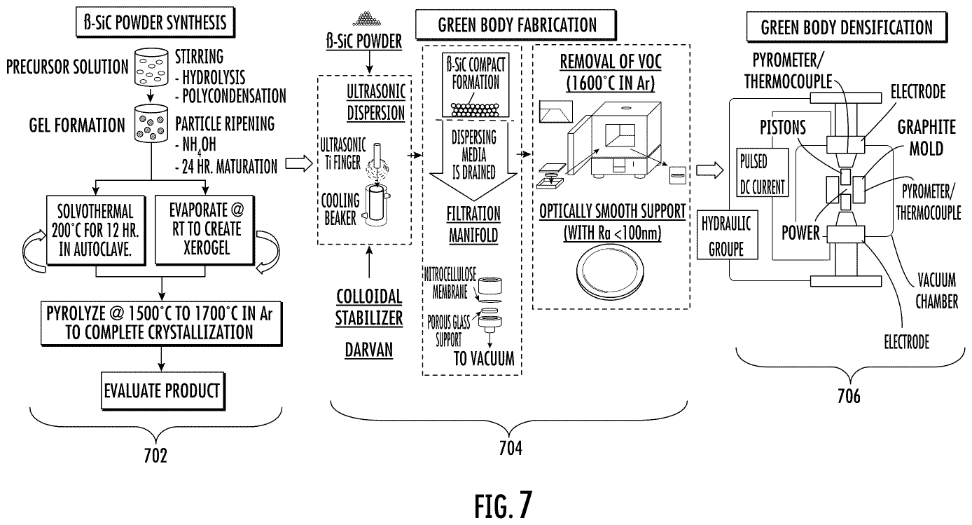

FIG. 7 is an example of one possible process flow for manufacturing transparent ceramic windows for hypersonic applications, consistent with the present disclosure. It should be noted that the example process illustrated in FIG. 7 is merely one possible process for manufacturing transparent ceramic windows for hypersonic applications. Many other processes may be used as would be known to a person of skill in the art.

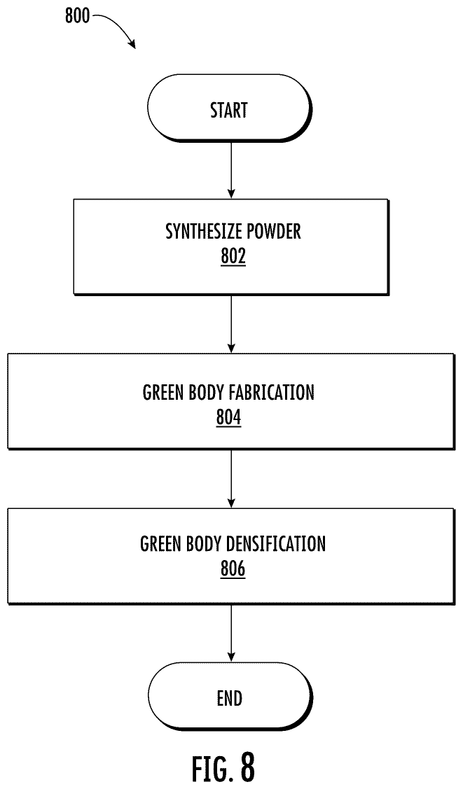

In the example process illustrated in FIG. 7, the β-SiC powder is synthesized in operation 702. This operation is further described in operation 802 of FIG. 8 below. The green body fabrication 704 is further described in operation 804 of FIG. 8 below. Finally, the green body densification 706 is further described in operation 806 of FIG. 8 below.

FIG. 8 is a flow chart diagram of workflow 800 depicting operations for the synthesis of a transparent ceramic windows for hypersonic applications, in accordance with an embodiment of the present disclosure.

It should be appreciated that embodiments of the present disclosure provide at least for manufacturing transparent ceramic windows for hypersonic applications. However, FIG. 8 provides only an illustration of one implementation and does not imply any limitations with regard to the environments in which different embodiments may be implemented. Many modifications to the depicted environment may be made by those skilled in the art without departing from the scope of the disclosure as recited by the claims.

In the illustrated example 800, the powder is synthesized (operation 802). In the illustrated example embodiment, the β-SiC powder is synthesized from a precursor solution. First the precursor solution is condensed into a gel, and then the gel is reduced by evaporation. Finally, the reduced gel is pyrolyzed to complete crystallization of the gel into the powder, resulting in a high purity β-SiC powder with a cubic crystal structure.

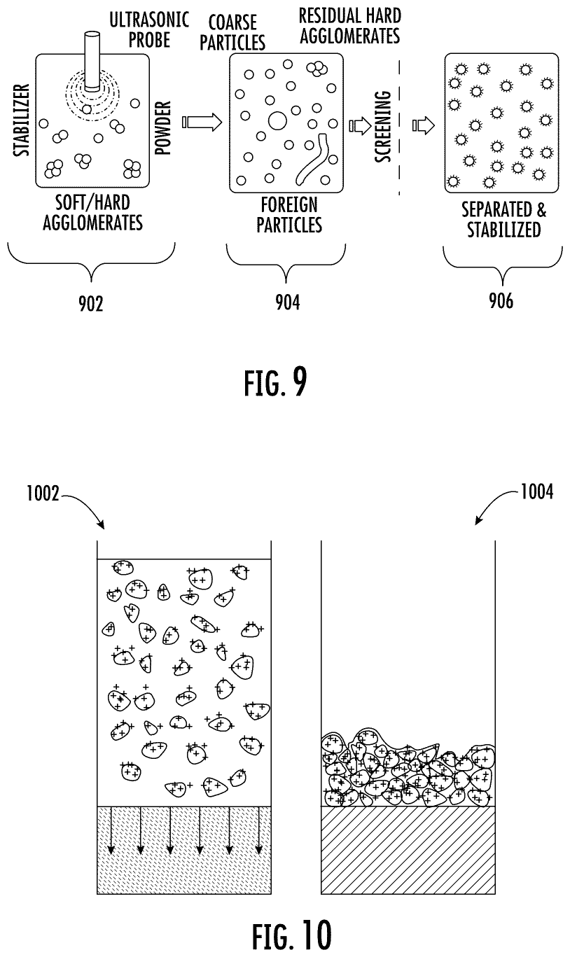

The green body is fabricated (operation 804). The green body is fabricated by dispersing the β-SiC powder in a dispersing media using a colloidal process. In some embodiments, the dispersing media is a colloidal stabilizer. See FIGS. 9 and 10 for details on the colloidal process.

The green body densification is performed (operation 806). In some embodiments, the green body densification is performed using Spark Plasma Sintering (SPS). SPS is a pressure-assisted pulsed-current process in which the powder samples are loaded in an electrically conducting die and sintered under a uniaxial pressure. In other embodiments, any other sintering process may be used as would be known to a person of skill in the art. In some embodiments, a pressureless sintering process is used where the temperature of the sintering process is below 1500 degrees Celsius (° C.) to minimize or eliminate grain growth.

FIG. 9 is an illustration of a colloidal process, consistent with the present disclosure. The colloidal stabilizer is chosen based on the surface energy and surface chemistry, as well as the particle size and size distribution of the β-SiC powder. In some embodiments, the β-SiC powder may be dispersed using ultrasonic dispersion to distribute the particles. As shown in operation 902, ultrasonic dispersion is used to disperse the β-SiC powder in the colloidal stabilizer. Operation 904 illustrates the colloidal stabilizer after the ultrasonic dispersion, with residual hard agglomerates and foreign particles. After dispersion, the dispersing media is drained, followed by removal of Volatile Organic Compounds (VOCs). Filtering the colloidal stabilizer in operation 906 removes the foreign particles and yields a separated and stabilized solution. The result is the green body compact.

In some embodiments, the dispersing media is then drained using vacuum filtration to produce polycrystalline ceramic pre-sinter compacts with minimal macro defects and increased particle packing uniformity.

FIG. 10 is an illustration of a colloidal process using vacuum filtration, consistent with the present disclosure. In the illustration of FIG. 10, the colloidal suspension is shown before (1002) and after (1004) vacuum filtration.

Important factors in the characterization of the pre-sinter part includes pore size distribution (i.e., the physical adsorption of N2), the pore morphology and uniformity, and the densification process, including the control of shrinkage vs. temperature and control of grain growth during densification. Greater control of the compact formation greatly minimizes warping and cracking during the drying process.

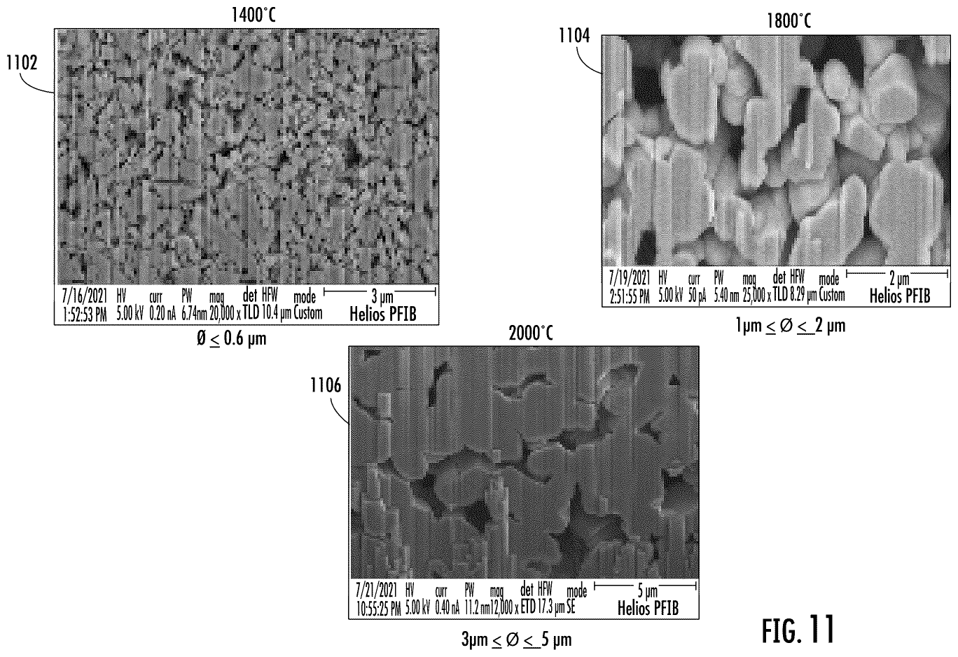

FIG. 11 demonstrates the effect of the sintering temperature on grain growth. As shown in image 1102, sintering at approximately 1400° C. yields a grain size with a diameter less than 0.6 micrometer (μm). But as shown in image 1104, sintering at approximately 1800° C. yields a grain size with a diameter between 1 μm and 2 μm, and as shown in image 1106, sintering at approximately 2000° C. yields a grain size with a diameter between 3 μm and 5 μm. Sintering at these elevated temperatures therefore leads to large grain sizes, and reduces optical transmittance. In addition, a secondary phase may be produced in the ceramic compact when sintered at high temperatures, such as 2,000° C.

According to one aspect of the disclosure there is thus provided a process for synthesizing transparent ceramic windows, the process comprising: synthesizing a powder; fabricating a green body from the powder; and densifying the green body.

According to another aspect of the disclosure there is thus provided a process to synthesize transparent ceramic windows, the process comprising: condensing a precursor solution to form a gel; reducing the gel by evaporation; pyrolyzing the gel to complete crystallization of the gel into a powder; dispersing the powder in a colloidal stabilizer using ultrasonic dispersion; draining a dispersing media from the colloidal stabilizer; removing volatile organic compounds from the colloidal stabilizer; and filtering the colloidal stabilizer to remove foreign particles to yield a green body; loading the green body into an electrically conducting die; and sintering the powder under a uniaxial pressure.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A process to synthesize transparent ceramic windows, the process comprising:
synthesizing a powder;
fabricating a green body from the powder; and
densifying the green body.

2. The process of claim 1, wherein synthesizing the powder further comprises:
condensing a precursor solution to form a gel;
reducing the gel by evaporation; and
pyrolyzing the gel to complete crystallization of the gel into the powder.

3. The process of claim 1, wherein the powder is beta silicon carbide (β-SiC).

4. The process of claim 1, wherein fabricating the green body from the powder further comprises:
dispersing the powder in a colloidal stabilizer using ultrasonic dispersion;
draining a dispersing media from the colloidal stabilizer;
removing volatile organic compounds from the colloidal stabilizer; and
filtering the colloidal stabilizer to remove foreign particles to yield a separated and stabilized solution.

5. The process of claim 1, wherein fabricating the green body from the powder further comprises:
dispersing the powder in a dispersing media; and
draining the dispersing media.

6. The process of claim 5, wherein the powder is dispersed using ultrasonic dispersion.

7. The process of claim 5, wherein the dispersing media is a colloidal stabilizer.

8. The process of claim 5, wherein the dispersing media is drained using vacuum filtration.

9. The process of claim 1, wherein densifying the green body further comprises:
using a rapid thermal treatment to densify the green body.

10. The process of claim 9, wherein the rapid thermal treatment is spark plasma sintering.

11. The process of claim 10, wherein the spark plasma sintering is performed at a temperature below 1500 degrees Celsius.

12. The process of claim 1, wherein densifying the green body further comprises:
loading the powder into an electrically conducting die; and
sintering the powder under a uniaxial pressure.

13. The process of claim 1, wherein the green body has a density of at least 60%.

14. A process to synthesize transparent ceramic windows, the process comprising:
condensing a precursor solution to form a gel;
reducing the gel by evaporation;
pyrolyzing the gel to complete crystallization of the gel into a powder;
dispersing the powder in a colloidal stabilizer using ultrasonic dispersion;
draining a dispersing media from the colloidal stabilizer;
removing volatile organic compounds from the colloidal stabilizer; and
filtering the colloidal stabilizer to remove foreign particles to yield a green body;
loading the green body into an electrically conducting die; and
sintering the powder under a uniaxial pressure.

15. The process of claim 14, wherein the powder is beta silicon carbide (β SiC).

16. The process of claim 14, wherein sintering the powder under the uniaxial pressure further comprises:
using spark plasma sintering.

17. The process of claim 16, wherein the spark plasma sintering is performed at a temperature below 1500 degrees Celsius.

18. The process of claim 14, wherein the green body has a density of at least 60%.

19. The process of claim 14, wherein the powder is dispersed using ultrasonic dispersion.

20. The process of claim 14, wherein the dispersing media is drained using vacuum filtration.
